(19) United States
(12) Patent Application Publication
(10) Pub. No.: US 2024/0165680 A1
(43) Pub. Date: May 23, 2024

(54) METHODS AND SYSTEMS FOR CLEANING AN ELECTRICALLY POWERED PORTABLE SELF-CONTAINED CLIMATE CONTROLLED STORAGE UNIT

(71) Applicant: THERMO KING LLC, Minneapolis, MN (US)

(72) Inventors: Paul J. Kroes, Eden Prairie, MN (US); Jason Tilghman, Minneapolis, MN (US); Ryan Wayne Schumacher, Bloomington, MN (US); Matthew Srnec, Minnetonka, MN (US); Srinivasa Rao Koppineedi, Eagan, MN (US)

(21) Appl. No.: 18/056,498

(22) Filed: Nov. 17, 2022

(51) Int. Cl. B08B 7/00; B08B 9/093

(52) U.S. Cl. CPC B08B 7/0057; B08B 9/093; B08B 2209/08

(57) ABSTRACT

Methods or systems for cleaning an electrically powered portable self-contained climate controlled storage unit is discussed. The methods or systems include a sensor monitoring a safety condition of the electrically powered portable self-contained climate controlled storage unit; a controller receiving a reading related to the safety condition from the sensor; the controller performing a safety check based on the reading received from the sensor; and the controller instructing the cleaning unit to clean the electrically powered portable self-contained climate controlled storage unit upon the controller determining the electrically powered portable self-contained climate controlled storage unit is safe to clean based on the safety check.

### FIELD

This disclosure relates generally to an electrically powered portable self-contained climate controlled storage unit. More particularly, the disclosure relates to methods and systems for cleaning an electrically powered portable self-contained climate controlled storage unit.

### BACKGROUND

A self-contained climate controlled storage unit, such as a refrigerated air freight container (e.g., Air100-RKN and AIR200-RAP from Thermo King and Envirotainer®, etc.), a portable refrigeration container (e.g., ColdCube™ container from Thermo King, Coldtainer® from Thermo King, etc.), etc., provides portable climate controlled storage for cargo (e.g., produce, frozen foods, pharmaceuticals, etc.). In some instances, the cargo can be high value/critical cargo. Self-contained climate controlled storage units are typically battery powered. The battery typically requires charging prior to transport so that the unit can provide and maintain climate control (e.g., temperature, humidity, pressure, etc.) without relying on external power. In many instances, regulatory agencies (e.g., Federal Aviation Administration—FAA, etc.) and trade associations (e.g., International Air Transport Association—IATA, etc.) provide regulations that impose strict performance specifications on self-contained climate controlled storage units. Failure to meet these regulations can result in refusal of certification and entry into, for example, an aircraft.

### SUMMARY

This disclosure relates generally to an electrically powered portable self-contained climate controlled storage unit. More particularly, the disclosure relates to methods and systems for cleaning an electrically powered portable self-contained climate controlled storage unit.

In an embodiment, a method for cleaning an electrically powered portable self-contained climate controlled storage unit is disclosed. The method includes a sensor monitoring a safety condition of the electrically powered portable self-contained climate controlled storage unit; a controller receiving a reading related to the safety condition from the sensor; the controller performing a safety check based on the reading received from the sensor; and the controller instructing the cleaning unit to clean the electrically powered portable self-contained climate controlled storage unit upon the controller determining the electrically powered portable self-contained climate controlled storage unit is safe to clean based on the safety check.

In an embodiment, the method includes the controller instructing the cleaning unit to stop cleaning the electrically powered portable self-contained climate controlled storage unit upon the controller determining the electrically powered portable self-contained climate controlled storage unit is unsafe to clean based on the safety check.

In an embodiment, the method includes the controller instructing to clean by turning on a UV-C source of the cleaning unit; and the UV-C source emitting UV-C light in the climate controlled space upon the UV-C source being turned on.

In an embodiment, an electrically powered portable self-contained climate controlled storage system is disclosed. The electrically powered portable self-contained climate controlled storage system includes electrically powered portable self-contained climate controlled storage unit includes a base supporting a climate controlled space, a climate control system configured to provide climate control to the climate controlled space, a door for provide access to the climate controlled space. The system includes a sensor configured to provide a reading related a safety condition of the electrically powered portable self-contained climate controlled storage unit; and a controller configured to receive the reading from the sensor, performing a safety check based on the reading received from the sensor, and instruct a cleaning unit to clean the electrically powered portable self-contained climate controlled storage unit upon the controller determining the electrically powered portable self-contained climate controlled storage unit is safe to clean based on the safety check.

In an embodiment, the electrically powered portable self-contained climate controlled storage system includes the controller instructing the cleaning unit to stop cleaning the electrically powered portable self-contained climate controlled storage unit upon the controller determining the electrically powered portable self-contained climate controlled storage unit is unsafe to clean based on the safety check.

In an embodiment, the cleaning unit includes a UV-C source disposed in the electrically powered portable self-contained climate controlled storage unit and configured to irradiate in the electrically powered portable self-contained climate controlled storage unit to clean the climate controlled space with UV-C light.

In an embodiment, the cleaning unit is disposed on a stand removable from the electrically powered portable self-contained climate controlled storage unit, and the stand supports the cleaning unit.

In an embodiment, the cleaning unit is disposed in the electrically powered portable self-contained climate controlled storage.

In an embodiment, the cleaning unit is disposed in a transport unit that is configured to transport the electrically powered portable self-contained climate controlled storage unit.

As such, systems and methods for cleaning the electrically powered portable electrically powered portable self-contained climate controlled storage unit has at least the following advantages. Since the electrically powered portable self-contained climate controlled storage unit (hereinafter referred to as a “storage unit”) is configured to check for safety condition(s) before proceeding to cleaning with UV-C, harsh chemicals, or the like, the safety of an operator and/or cargo in and near the storage unit can be improved. For example, the storage unit is configured to turn off the cleaning unit when the storage unit is determined to be occupied, such that the system is configured to keep the storage unit cleaned while minimizing risk of damage or injuries to humans and/or cargo, or the like.

### BRIEF DESCRIPTION OF THE DRAWINGS

References are made to the accompanying drawings that form a part of this disclosure and which illustrate the embodiments in which methods and systems described in this specification can be practiced.

FIG. 1 is a perspective view of a transport unit, according an embodiment.

FIG. 2 is a rear view of the transport unit, according to the embodiment of FIG. 1.

FIG. 3 is a perspective and schematic view of a storage unit, according to an embodiment.

FIG. 4 is a schematic view of a storage unit, according to an embodiment.

FIG. 5 is a schematic diagram of a controller, according to an embodiment.

FIG. 6 shows a method for cleaning a storage unit, according to an embodiment.

FIG. 7 shows a method for determining whether a storage unit is safe to clean based on a safety check, according to an embodiment.

Like reference numbers represent like parts throughout.

### DETAILED DESCRIPTION

This disclosure relates generally to an electrically powered portable self-contained climate controlled storage unit (PCU). More particularly, the disclosure relates to methods and systems for cleaning an electrically powered portable self-contained climate controlled storage unit.

It is noted that: U.S. application No. ______, “METHOD AND SYSTEM FOR MONITORING WEIGHT/ORIENTATION OF A SELF-CONTAINED CLIMATE CONTROLLED STORAGE UNIT AND ADJUSTING OPERATION BASED ON THE MONITORED WEIGHT/ORIENTATION,” (attorney docket no: 20420.1032US01); U.S. application No. ______, “ELECTRICALLY POWERED PORTABLE SELF-CONTAINED CLIMATE CONTROLLED STORAGE UNIT,” (attorney docket no: 20420.1032USS1); U.S. application No. ______, “METHODS AND SYSTEMS FOR POWER SHARING AND CHARGING COORDINATION OF SELF-CONTAINED CLIMATE CONTROLLED STORAGE UNIT(S),” (attorney docket no: 20420.1034US01); and U.S. application No. ______, “METHOD AND SYSTEM FOR PROVIDING AN INDICATION OF A SYSTEM OPERATING STATUS OR LOGISTICAL OPERATION STATUS OF A SELF-CONTAINED CLIMATE CONTROLLED STORAGE UNIT,” (attorney docket no: 20420.1036US01); all filed concurrently herewith on Nov. ______, 2022, and the contents of which are incorporated herein by reference.

The terms “above”, “below”, “top”, “bottom”, “left”, “right”, and the like described in the present application are defined according to the typical observation angle of a person skilled in the art and for the convenience of the description. These terms are not limited to specific directions but provided for ease of understanding the disclosure. As such, the terms should be interpreted broadly and can include, but not limited to, being directly adjacent, near, or spaced apart from the respective components.

A storage unit, such as a refrigerated air freight container (e.g., Air100-RKN and AIR200-RAP from Thermo King and Envirotainer®, etc.), a portable refrigeration container (e.g., ColdCube™ container from Thermo King, Coldtainer® from Thermo King, etc.), etc., provides portable climate controlled storage for cargo (e.g., produce, frozen foods, pharmaceuticals, biologicals, for example, human tissue, blood, heart, and lung, etc.). In some instances, the cargo can be high value/critical cargo. PCUs are typically battery powered. A storage unit, as defined herein, is capable of autonomous operation (e.g., for a week or more) via battery power. In some embodiments, a full pallet of PCUs can be transported within a transport unit (e.g., a truck, a van, a trailer, an intermodal container, an airplane, etc.). In some embodiments, one or more PCUs can be transported in a vehicle by attaching to the vehicle, for example, by strapping to the bed of a pickup truck or trailer. Embodiments of systems or methods for cleaning of a storage unit are described in additional detail below.

The methods and systems described herein are directed to a storage unit that can be transported in a climate controlled or non-climate controlled transport unit, such as, airplanes, railways, trucks, vans, trailers, intermodal containers, or other similar transport units, and that can self-monitor the weight and/or orientation associated with the storage unit during transport and/or handling.

PCUs can be recharged by connecting to an electricity source, for example, by plugging into an electrical outlet, by connecting to an onboard generator, by receiving power generated from a solar panel, by replacing a removable battery, or the like.

While some of the embodiments discussed below are discussed with respect to a freight container, one skilled in the art would recognize the embodiments discussed herein can be provided for any type of PCU (e.g., air freight containers, portable refrigerated storage boxes, etc.).

The storage unit can have a climate controlled space disposed therein. The climate controlled space can have an internal dimension of a width of about 30 inches to 60 inches, or at about 42 inches for accommodating a standard pallet. The height of the climate controlled space can be between 36 inches and 120 inches, or between 36 inches and 72 inches, since at larger heights, the center of gravity of the storage unit may be higher and could be prone to tipping, e.g., during transportation. It is understood that such disclosure is not intended to be limiting in scope, but provided for understanding the disclosure.

Methods and systems for cleaning a storage unit are described. It is appreciated that cleaning can include sanitizing, disinfecting, sterilizing, or the like, as required and/or defined by regulation authorities and/or understood by one of ordinary skill in the art. Cleaning can include physical, chemical, and/or biological means to remove, reduce, and/or eliminate dusts, debris, greases, microbial (e.g., fungi, bacteria, virus, yeast, etc.), and/or other materials from a surface or space being cleaned. For example, physical means can include spraying with a cleaning fluid (e.g., water, cleaning solution, or the like), blowing with air, exposing to heat or cold temperature, dried air, radiation (e.g., by UV-C light from a UV-C source), or the like. Chemical or biological means can include exposing the surface or space being cleaned with soap, disinfectants, alcohol, chemical gas, enzymatic cleaners, or the like.

Some aspects of cleaning a storage unit may be harmful to human and/or other animals or damaging to cargo. For example, exposure of UV-C light, harsh/liquid chemicals, or the like from the cleaning unit may be prevented and thus prevent potential damage to human organs (e.g., skin or eyes) from irritation, burns, or the like. For another example, exposure of UV-C light, harsh/liquid chemicals, or the like from the cleaning unit may cause damage to cargo, e.g., by liquid damage to cardboard packaging, degrading products (e.g., UV activated materials), cleaning fluid contaminating the cargo, or the like. Embodiments of systems and/or methods for cleaning a storage unit can include a controller determining the safety condition for cleaning the storage unit being safe or unsafe to clean based on at least one sensor disposed in the storage unit and/or a transport unit housing and transporting the storage unit. For example, the controller can prevent the cleaning unit from turning on or can turn off the cleaning unit, when the controller determines that the storage unit is unsafe to clean.

A surface or area being cleaned by the cleaning unit can include an interior or inside of the storage unit (e.g., the climate controlled space of the storage unit) or the like. In some embodiments, the surface or area being cleaned by the cleaning unit may be an exterior surface of the storage unit, for example, by a cleaning unit disposed in a transport unit housing and transporting the storage unit.

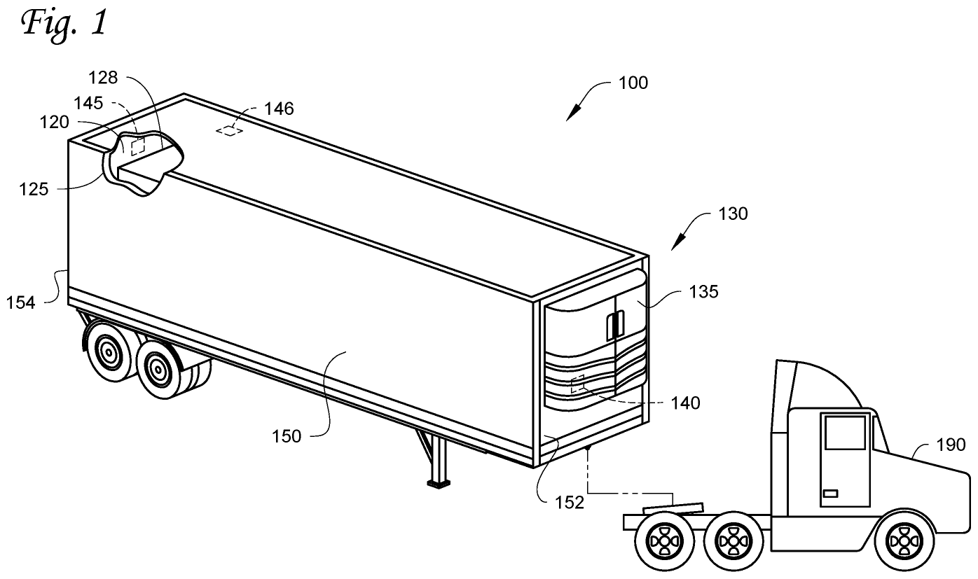

FIG. 1 is a perspective view of a climate controlled transport unit 100, according an embodiment.

As shown in FIG. 1, the climate controlled transport unit 100 includes a transport climate control system (TCS) 130 configured to provide climate control to a climate controlled space 120 during transportation, storage, or the like. The climate controlled space 120 can be a volume in the transport unit (TU) 150 for housing cargo, for example, during transportation, storage, or the like. In some embodiments, the TU 150 can be attached (e.g., towed, carried, strapped, etc.) to a vehicle 190 that is configured to move the TU 150.

The TCS 130 can provide climate control to the climate controlled space 120. In some embodiments, the TCS 130 can include a climate control unit 135, and/or at least one sensor (e.g., 140, 145, 146), controller, monitor, or the like.

Climate control can include controlling a climate condition in the climate controlled space 120. The climate condition can include temperature, humidity, pressure, air flow, air quality, and/or the like. In an embodiment, the TCS 130 can provide climate control via a mechanical vapor compression cycle that comprises, e.g., a compressor, an expander, an evaporator, and a condenser fluidly connected by a working fluid. The working fluid can include a refrigerant. In an embodiment, the TCS 130 can include a heater, an air filter, a passive climate control system (e.g., liquid nitrogen, dry ice, or the like) or the like.

The climate control unit 135 can be configured to contain mechanical and electrical systems that provide climate control. For example, the climate control unit 135 can include the compressor, the expander, the evaporator, the condenser, or the like. In an embodiment, the climate control unit 135 can be configured to contain at least some of the mechanical and electrical systems that provide climate control.

The at least one sensor (e.g., 140, 145, 146) can be configured to measure one or more condition of the TCS 130. For example, the sensors can be configured to acquire a reading or measurement and transmit the reading or measurement to a controller. The reading or measurement can be related to at least one climate condition, operating condition, and/or safety condition. The reading or measurement related to at least one climate condition can include temperature, pressure, humidity, air flow, air quality, or the like. In some embodiments, the reading or measurement related to at least one operating condition can include location sensor, security sensors, conditions of communication sensors/equipment, or the like. The reading or measurement related a safety condition can include any climate condition, operating condition, or a combination thereof, such that a controller can determine a safety condition (e.g., whether a space or area is occupied, and/or safe to clean, or the like). The at least one sensor can be disposed in the climate control unit 135, the TU 150, and/or the like.

In an embodiment, the at least one sensor can be disposed on in the climate control unit 135, e.g., the sensor 140, and/or disposed in the TU 100, e.g., the sensor 145. In an embodiment, the at least one sensor can be disposed outside the transport unit 146. In some embodiments, the sensors can be configured to measure the condition inside and/or outside the TU 150, the climate controlled transport unit 100, and/or the like.

The TU 150 houses the climate controlled space 120 (shown by an illustrated see-through opening 125). Cargo 128 can be housed in the climate controlled space 120. As illustrated in FIG. 1, the climate control unit 135 of the TCS 130 can be attached to a front 152 of the TU 150. In some embodiments, one or more accesses can be provided on the TU 150 for accessing, for example, the climate controlled space 120. In some embodiments, the one or more accesses can be one or more doors, for example, located on the front 152, a rear 154, a side, a top, of the TU 150, or the like.

The vehicle 190 shown in FIG. 1 is a tractor. In other embodiments, the vehicle 190 can be a van, a truck, a train cart or chassis, a boat, a ship, or the like.

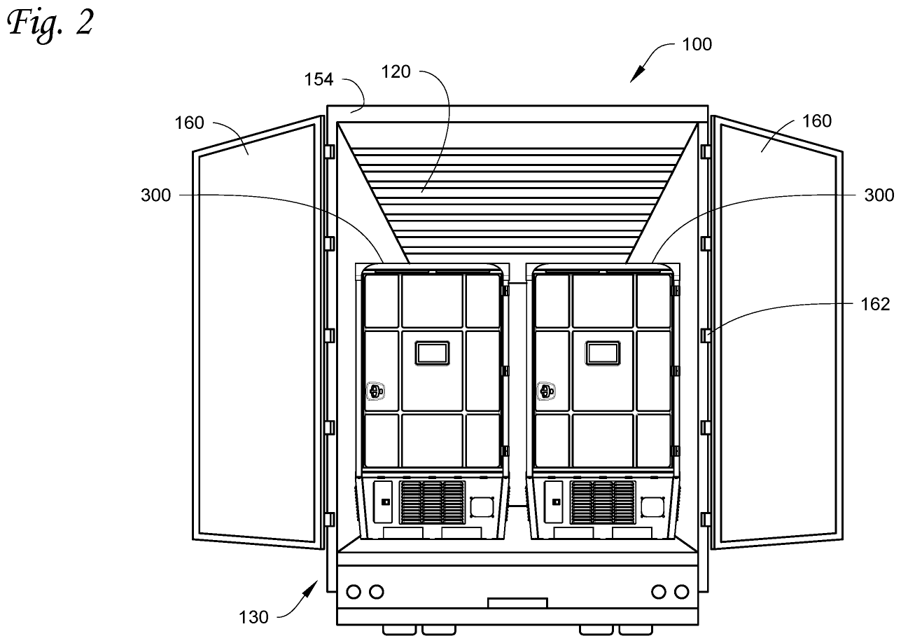

FIG. 2 is a rear view of the climate controlled transport unit 100, according to the embodiment of FIG. 1.

As shown in FIG. 2, the climate controlled transport unit 100 can include one or more doors 160 disposed on the rear 154 of the TU 150 for providing access to the climate controlled space 120. In some embodiments, the doors 160 can be disposed on the TU 150 by one or more hinges 162 hanging the doors 160 to the TU 150.

One or more electrically powered portable self-contained climate controlled storage units (PCU) 300 can be disposed inside the TU 150. In an embodiment, PCU 300 can be the primary source of climate control for the climate controlled spaces within the storage unit 300 such that the transport unit 100 can provide supplemental, backup, passive climate control, or the like. Passive climate control of the transport unit 100 can include insulation disposed in the TU 150, one or more accesses (e.g., doors, hatches, louvers panels, windows, or the like) to allow airflow, or the like. For example, the storage unit 300 is configured to be placed in the climate controlled transport unit 100 to provide backup climate control to the climate controlled spaces within the storage unit 300 should the TCS 130 is turned off.

In an embodiment, the storage unit 300 can be configured to provide supplemental climate control to the climate controlled space inside the storage unit 300 such that the climate condition inside the storage unit 300 can be different from the climate condition in the TU 150 (e.g., outside the storage unit 300 and inside the climate controlled space 120).

Referring to FIG. 2, the storage unit 300 can be placed in the TU 150. It is appreciated that due to the dimensions of the storage unit 300, the storage unit 300 can be placed side by side and front to back in the TU 150 for compact packing and transport of the storage unit 300. As such, the storage unit 300 can individually provide the climate control requirements for the cargo housed in the climate controlled spaced respectively in the storage unit 300, for example, based on the climate control requirement of the cargo housed therein.

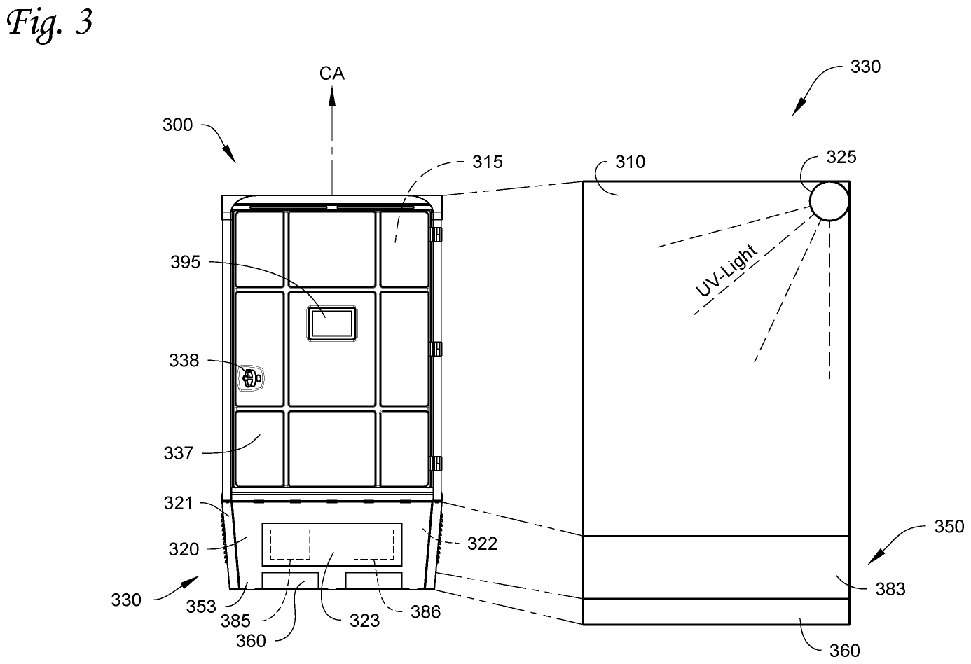

FIG. 3 is a perspective and schematic view of the storage unit 300, according to an embodiment.

The storage unit 300 can be an electrically powered portable self-contained climate controlled storage unit. The storage unit 300 can be powered by a battery disposed in the storage unit 300. The storage unit 300 can be portable, for example, by human power, forklift, hand truck or the like, such that the storage unit 300 can be carried in and out of the TU 150. The storage unit 300 can be fully or partially powered by electricity from a battery included in the storage unit 300 for providing climate control within an interior space 315 in the storage unit 300. It is appreciated that the storage unit 300 can be configured to be transported within a shipping container, a containerized truck, or the like, and be provide some or all the climate control capacity to the interior space 315. In an embodiment, the interior space 315, or a portion of the interior space 315, can be a climate controlled space 310. In some embodiments, the storage unit 300 can be transported within a transport unit (e.g., TU 150 of FIGS. 1 and 2) as, for example, the cargo of the TU 150.

As shown in FIG. 3, the storage unit 300 includes a climate controlled space 310 and a base 320 supporting the climate controlled space 310. The climate controlled space 310 can be affixed above the base 320, e.g., vertically above the base 320, directly above, or to a side of the base 320. The storage unit 300 also includes a climate control system 330 for cooling and/or heating the climate controlled space 310, and a system controller 385 connected to the storage unit 300. As shown in FIG. 3, the storage unit 300 also includes a power source 386 for supplying power to the climate control system 330.

The climate controlled space 310 includes an insulated housing having an interior space 315 for housing cargo. In the illustrated embodiment, the insulated housing can include insulated side, bottom, and top walls configured to generally conform to the shape required of the storage unit 300. Access to the interior space 315 can be provided via a door 337 disposed on the storage unit 300 for enclosing and/or accessing the cargo. FIG. 3 illustrates a perspective view of the storage unit 300 in which the door 337 is closed. The door 337 can be kept closed by a securing mechanism 338. The securing mechanism 338 can be operable and accessible via keypad, biometrics, web, key card, mobile, a combination of the same, or the like.

In an embodiment, the climate controlled space 310 can have a width of about 30 inches to 60 inches, or at about 42 inches for accommodating a standard pallet in the interior space 315. The height of the climate controlled space 310 can be between 36 inches and 120 inches, or between 36 inches and 72 inches, since at larger heights, the center of gravity of the storage unit 300 may be higher and could be prone to tipping. It is understood that such disclosure is not intended to be limiting in scope, but provided for understanding the disclosure.

The base 320 includes a housing 321 having an enclosure 322 and a plurality of feet 353 for supporting the storage unit 300. In the embodiment shown in FIG. 3, the enclosure 322 includes the climate control system 330, a system controller 385, and the power source 386. The enclosure 322 can be accessible via a panel 323 or door 323 on the housing 321. In an embodiment, the plurality of feet 353 is positioned to support the storage unit 300. The plurality of feet 353 is provided at least at the corners of the base 320 and/or at or along a center of the base 320 and/or along the edges of the base 320. Slots or openings 360 are provided between the plurality of feet 353. In some embodiments, the slots or openings 360 can have a width for accepting forks or tines of a forklift or for engaging other lifting and handling machines. In an embodiment, the plurality of feet 353 can include wheels or retractable wheels, e.g., manual, hydraulic, piston driven, or the like, to allow the moving or repositioning of the storage unit 300 without a lifting and handling machine.

The climate control system 330 can be configured to provide climate control (e.g., temperature, humidity, atmosphere, etc.) within the interior space 315. In particular, the climate control system 330 can provide climate control to maintain fresh and/or frozen cargo or provide heated storage for cargo housed within the interior space 315 via vents and/or communication channels or ducts through the walls of the storage unit 300. It will be appreciated that the particular cargo is not limiting. For example, in an embodiment, the cargo can include perishable items such as food, while in another embodiment the cargo can include pharmaceuticals, biologics, or medical equipment, blood, organs, or the like. In an embodiment, the climate control system 330 can include one or more climate control circuits (not shown). Each of the one or more climate control circuits can include, for example, a compressor, a condenser, an evaporator, and an expansion valve. In an embodiment, one or more condensers (not shown), one or more condenser fans (not shown), and one or more electrical components (e.g., valve(s)) (not shown) can be housed within the climate control system 330. There can also be one or more evaporators (not shown) and one or more evaporator fans (not shown) housed within one or both of the enclosure 322 and the interior space 315 to provide climate control within the interior space 315.

The climate control system 330 can control one or more conditions in the interior space 315. The conditions can include one or more climate conditions (e.g., temperature, pressure, humidity, or the like), one or more operating conditions (e.g., location sensor, security sensors, conditions of communication sensors/equipment, or the like), or the like. In an embodiment, the climate control system 330 can provide climate control via a mechanical vapor compression cycle.

The climate control system 330 can provide climate control such as cooling, heating, humidity control, or the like. The climate control system 330 can include one or more pieces of climate control equipment or components for controlling the climate conditions in the storage unit 300. The climate control system 330 can include mechanical and electrical systems that provide climate control. In an embodiment, the climate control system 330 can include components for the mechanical vapor compression cycle. For example, climate control system 330 can include and/or contain the compressor, the expander, the evaporator, the condenser, or the like. The climate control system 330 can include, e.g., the compressor, the expander, the evaporator, and the condenser fluidly connected by a working fluid. The working fluid can include a refrigerant.

In an embodiment, the climate control system 330 can include a heater, an air filter, a passive climate control system (e.g., liquid nitrogen, dry ice, insulated wall, or the like) or the like. In some embodiments, the climate control system 330 can provide climate control to the interior space 315 disposed in the climate controlled space 310.

The system controller 385 can be configured to control and communicate with the storage unit 300, one or more electrical components, at least one sensor, and/or the climate control system 330, e.g., the compressor, the one or more condensers, and/or evaporator fans, etc. The system controller 385 can include a processor and memory for storing data and instructions. In an embodiment, the system controller 385 can be connected to a human machine interface (HMI) 395 that can be powered by the power source (e.g., as discussed below as power source 386). The HMI 395 can include a display, touchscreen, keypad, or the like as an interface for controlling or programming of the storage unit 300, displaying information related to the storage unit 300, or the like. In an embodiment, the information can include shipment details, weight, cargo, battery power, alert/alarm conditions, temperature, humidity, max and min temperatures, or the like. In an embodiment, the HMI 395 can be integrated with the securing mechanism which has a display for displaying such information.

The power source 386 can be configured to power the storage unit 300, the system controller 385, and/or the climate control system 330. The power source 386 can include a battery source (not shown), e.g., battery powered. The battery source 386 can be supplied with an energy supply source when the self-contained climate controlled storage units are in the climate controlled transport unit or can be supplied with energy (i.e., charged/recharged) prior to being loaded and transported in a transport unit. The battery source 386 can be configured to provide electrical energy to, for example, the system controller 385, the one or more electrical components, the compressor, the one or more condensers and/or evaporator fans, etc.

The battery source 386 can include one or more battery banks (not shown) with a DC and/or AC charge input (not shown) configured to allow an external power source to charge the one or more battery banks. When charge input includes a DC charge input, the battery source 386 can also include a DC charge controller, a DC isolation connection, and a DC disconnect switch. When the charge input includes an AC charge input, the battery source 386 can also include an AC inverter, an AC charger, and an AC disconnect switch and a breaker panel.

The climate controlled space 310 can include one or more walls, floors, and/or ceilings separating the inside from the outside of the climate controlled space 310 and enclose a volume therein. The one or more walls, floors, and ceilings can include insulated layers or panel(s) for controlling or reducing heat transfer between the volume therein and the outside of the climate controlled space 310. Storage unit equipment, such as a cleaning unit, a lock, a door, a user interface, one or more sensors, and the like, can be disposed on, or connected via, the one or more walls, floors, and/or ceilings of the climate controlled space 310. The interior space 315 can be disposed in the volume in the climate controlled space 310.

In an embodiment, the climate controlled space 310 can include one or more insulated ceilings, walls, and floors configured to generally conform to the shape required of the climate controlled space 310. Access to the climate controlled space 310 can be provided by a door 337 for enclosing and/or accessing the cargo disposed in the climate controlled space 310. In some embodiments, the door 318 can attach to the climate controlled space 310 by hanging, hinging, rolling, or the like.

The storage unit 300 can include a cleaning unit 325, such as a UV-C source, a fluid cleaner, or the like. The cleaning unit 325 can be configured to clean the storage unit 300 so that the cleanliness of the storage unit 300 is improved or maintained. For example, the cleaning unit 325 can be configured to clean an interior of the storage unit 300, such as, the interior space 315. It is appreciated that the cleaning unit 325 may be not limited to clean an interior of the storage unit 300. For example, the cleaning unit 325 can be configured to clean an exterior and/or outside of the storage unit 300, for example by being disposed and/or protruded outside the storage unit 300 and cleaning by radiating or spraying on an exterior surface of the storage unit 300.

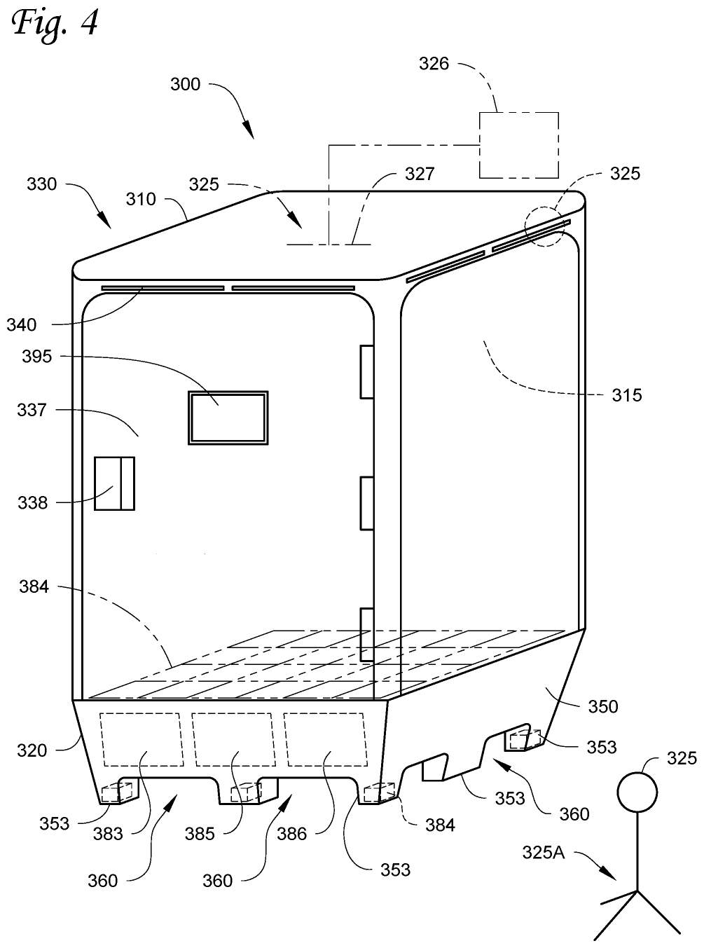

FIG. 4 is a schematic view of the storage unit 300, according to an embodiment. As shown in FIG. 4, the door 337 of the storage unit 300 is closed.

As shown in FIG. 4, the storage unit 300 includes a securing mechanism 338 that can operate and/or keep the door 337 at a desirable position relative to the storage unit 300, such as, opened, closed, latched, locked, partially open at a predetermined degrees relative to a wall of the storage unit 300 or the like. The securing mechanism 338 can be a door opener, a keypad, biometrics reader, a controller, a lock, a key card reader, an onboard or remote user interface, or the like, or a combination thereof.

The storage unit 300 includes climate control system 330. The climate control system 330 can provide climate control such as cooling, heating, humidity control, or the like. In some embodiments, the climate control system 330 can include a climate control unit 383, at least one sensor 384, a controller 385, and a power source 386. The climate control system 330 can include a climate control unit 383 and/or at least one sensor 384.

The climate control unit 383 can include one or more components for the climate control unit 320 (e.g., components for the mechanical vapor compression cycle, heater, air filter, or the like) that can be disposed in the base 320. In an embodiment, the climate control unit 383 can include a heater, an air filter, a passive climate control system (e.g., liquid nitrogen, dry ice, wall insulation, or the like) or the like.

The sensor 384 can be disposed in the storage unit 300 and configured to measure one or more conditions of the storage unit 300, for example, a condition of the storage unit 300 that is internal and/or external of the storage unit 300. The sensor 384 can transmit one or more sensor reading to and be received by the system controller 385.

The system controller 385 can receive the one or more measurements from the at least one sensor 384 related of the storage unit 300. The system controller 385 can receive the safety condition and determine a safety condition based on the measurements or readings received from the sensor 384. The cleaning safety condition can, for example, an indication that the storage unit 300 is safe to clean or unsafe to clean. The safety condition can be safe to clean, for example, when the system controller 385 determined that PCU 300 is empty (e.g., no weight of the cargo housed or operator in the storage unit 300), when the system controller 385 determines that the door 337 of the storage unit 300 is closed and/or secured, when a button or switch is activated, or the like, or a combination thereof. For example, the cleaning safety condition can be safe to clean when the storage unit 300 is empty and the door 337 is closed. The cleaning safety condition can be unsafe to clean when the storage unit 300 occupied by cargo or the door 337 is open.

It is appreciated that the system controller 385 can be located in the storage unit 300 to provide instructions, for example, to the cleaning unit based on the readings or measurements received from the sensor 384. In some embodiments, the system controller 385 can communicate with a remote system to determine and transmit instructions to the cleaning unit 325 remotely. A remote system can utilize the computational power of a remote system, conserving onboard energy, serviceability, reliability, or the like. The storage unit 300 can include one or more radio transmitters to send and/or receive sensor measurements and/or instructions.

The system controller 385 can use the at least one sensor 384 to measure a condition related to the storage unit 300. For example, the sensor 384 can acquire a measurement of a condition related to the storage unit 300. The measurement can be provided to the system controller 385 to determine the safety condition of the storage unit 300. The measurement can be provided for the system controller 385 to conduct a safety check to determine a condition being safe or unsafe to clean using, for example, the cleaning unit 325.

In an embodiment, the sensor 384 can be an occupancy sensor that provides a measure to the system controller 385 to conduct a safety check. The safety check can include determining an occupancy of, for example, the interior space 315 of the storage unit 300. The safety check can determine based on the measurement acquired from the sensor 354 to determine an occupancy of cargo, users, intruders, animals, equipment, or the like. For example, an occupancy sensor can include at least one weight sensor for the storage unit 300. The weight sensor can be configured to measure the weight of the cargo or operator in the climate controlled space 310, the gross weight of the storage unit 300, or the like. The system controller 385 can receive the measurement from the weight sensor and determine whether the storage unit 300 is occupied by cargo or an operator, determine whether the gross weight of the storage unit 300 is above a predetermined weight threshold to deduce that the container is occupied by cargo, user, equipment, or the liquid. For example, the predetermined weight threshold can be the weight of the storage unit 300 being empty.

In an embodiment, the sensor 384 can be a door sensor that provides a measurement or reading to the system controller 385 to determine a position of a door (e.g., 337) that provides access to the climate controlled space 310 (e.g., the interior space 315 of the storage unit 300). The door sensor can include a mechanical switch or system, a mechanical/magnetic switch or system, a virtual doors sensor (e.g., a camera and a computer vision system), or the like. The door sensor can acquire one or more measurements to determine the position of the door being, opened, closed, or partially closed relative to the storage unit 300. In some embodiments, the door sensor 384 can provide a measurement related to the position of the door such that the system controller 385 can determine the door being open, close, or the like, to determine the safety condition in instructing the cleaning unit 325. It is appreciated that the door sensor is not limited to acquire a measurement related to the door 337 as illustrated in FIG. 4 to provide access to human operator, cargo, equipment, or the like. In some embodiments, the door sensor can be configured to acquire a measurement related to other accesses such as a hatch, a window, or the like, for example, to prevent leakage. For example, the leakage of cleaning fluid or radiation out of the storage unit 300 can cause damage/injuries to passing by human or other objects positioned near the storage unit 300.

The base 320 includes the enclosure 322 and the plurality of feet 353 for supporting the base 320. In an embodiment, the climate control unit 383, the system controller 385, and the power source 385 are included in the enclosure 322. The enclosure 322 can be accessible via a panel or door. In an embodiment, the plurality of feet 353 is positioned to support the storage unit 300. The plurality of feet 353 is provided at least at the corners of the base 320 and/or at or along a center of the base 320 and/or along the edges of the base 320. Slots or openings are provided between the plurality of feet 353. In some embodiments, the slots or openings can have a width for accepting forks or tines of a forklift or for engaging other lifting and handling machines. In an embodiment, the plurality of feet 353 can include wheels or retractable wheels, e.g., manual, hydraulic, piston driven, or the like, to allow the moving or repositioning of the storage unit 300 without a lifting and handling machine.

The climate control unit 383 can be configured to provide climate control (e.g., temperature, humidity, pressure, etc.) in the interior space 315. In an embodiment, the climate control unit 383 can provide climate control to maintain fresh and/or frozen cargo or provide heated storage for cargo housed within the interior space 315 via vents and/or communication channels or ducts through the walls of the storage unit 300. It will be appreciated that the particular cargo is not limiting. For example, in an embodiment, the cargo can include perishable items such as food, while in another embodiment the cargo can include pharmaceuticals, biologics, or medical equipment, blood, organs, or the like.

In an embodiment, the climate control unit 383 can include one or more climate control circuits (not shown). Each of the one or more climate control circuits can include, for example, a compressor, a condenser, an evaporator, and an expansion valve. In an embodiment, one or more condensers (not shown), one or more condenser fans (not shown), and one or more electrical components (e.g., valve(s)) (not shown) can be housed within the climate control unit 383. There can also be one or more evaporators (not shown) and one or more evaporator fans (not shown) housed within one or both of the climate control unit 383 and the interior space 315 to provide climate control within the interior space 315.

The system controller 385 can be configured to control and communicate with the storage unit 300, one or more components, the at least one sensor 384, and/or the climate control unit 383, e.g., the compressor, the one or more condensers, and/or evaporator fans, etc. The system controller 385 can include a processor and a memory for providing instructions and storing data. In an embodiment, the system controller 385 can be connected to a human machine interface (HMI) 395. The HMI can be powered by the power source (e.g., as discussed below as power source 386), a dedicated power source (e.g., an HMI battery), and/or the like. The HMI 395 can include a display, touchscreen, keypad, or the like as an interface for controlling or programming of the storage unit 300, displaying information related to the storage unit 300, or the like. In an embodiment, the information can include shipment details, weight, cargo, battery power, alert/alarm conditions, temperature, humidity, max and min temperatures, or the like. In an embodiment, the HMI 395 can be integrated with the securing mechanism 338 which has a display for displaying such information. It is appreciated that the HMI 395 is not limited for an HMI 395 disposed on the storage unit 300 as illustrated in FIG. 4. For example, an HMI 395 can be detachable from the storage unit 300, a remote device, a user interface, or the like. For example, the user interface can be an application on an electronic device (e.g., tablet, laptop, smartphone, or the like), a web based user interface, a software or mobile app based user interface, or the like. In some embodiments, the system controller 385 can communicate with the HMI 395 via wired or wireless communication such as the internet, a cellphone network, a local wired or wireless network, Bluetooth, or the like.

The power source 386 can be configured to power the storage unit 300, the system controller 385, and/or the climate control unit 383. The power source 386 can include a battery source (not shown), e.g., battery powered. The battery source 386 can be supplied with an energy supply source when the storage unit 300 are in a transport unit (e.g. 150 of FIGS. 1 and 2) or can be supplied with energy (i.e., charged/recharged) prior to being loaded and transported in a transport unit. The battery source 386 can be configured to provide electrical energy to, for example, the system controller 385, the one or more electrical components, the compressor, the one or more condensers and/or evaporator fans, etc.

The battery source 386 can include one or more battery banks (not shown) with a DC and/or AC charge input (not shown) configured to allow an external power source to charge the one or more battery banks. When charge input includes a DC charge input, the battery source 386 can also include a DC charge controller, a DC isolation connection, and a DC disconnect switch. When the charge input includes an AC charge input, the battery source 386 can also include an AC inverter, an AC charger, and an AC disconnect switch and a breaker panel.

It is appreciated that, in an embodiment, the storage unit 300 can be configured such that a center of mass of the storage unit 300 is located along a central axis CA (shown in FIG. 3) of the base 320. That is, components, e.g., batteries, compressor, evaporator, etc., which have a weight associated therewith, are arranged in the base 3220 so that the center of mass of the storage unit 300 is located centrally, to provide a stable base for the storage unit 300. It is appreciated that the center of mass can be based on the total weight of the storage unit 300 and system components before the cargo is loaded into the storage unit. For example, since the center of mass can be based on the total weight of the storage unit 300, with most of the weight being provided by the base 320, the center of mass can be located several inches, e.g., between 6 inches and 20 inches, above the base 320 along the central axis CA.

It is appreciated that the sensor 384 can be provided for measuring a weight and/or orientation associated with the storage unit 300. The sensor 384 can be a pressure sensor or a load sensor or cell. The sensor 384 can be provided in one or more of the plurality of feet 353 of the base 320. In another embodiment, the sensor 384 can be provided between the climate controlled space 310 and the base 320 to measure the weight of the cargo. In another embodiment, the storage unit 300 can include a plurality of sensors 384 provided at different locations or a combination of locations on the storage unit 300. For example, the sensors can be provided on the plurality of feet 353 and in the slots or openings to determine whether the storage unit 300 is being lifted. It is appreciated that the disclosure of the placement of the sensor is not intended to be limiting, but rather provided to discuss some of the combinations of sensor arrangements on the storage unit 300 to provide different data for analysis and/or processing by the system controller 385, as further discussed below.

It is appreciated that PCU 300 can include additional and/or alternative sensor(s) for measuring another condition (i.e., climate control and/or operating condition) of the storage unit 300. In an embodiment, the storage unit 300 can be an accelerometer or inertial monitor for measuring an acceleration associated with the storage unit 300 and/or an inclinometer for measuring an inclination of the storage unit 300. In another embodiment, the storage unit 300 can include a temperature sensor, humidity sensor, or the like for monitoring the environmental conditions of the climate controlled space 310 of the storage unit 300, ambient environment of the storage unit 300, or the like. In some embodiments, the storage unit 300 can include sensors such as location sensor (e.g., GPS sensor), radio transmitter, camera, light sensors, mechanical or virtual switches/sensors, or the like.

In view of such various arrangements of the sensor(s) 384 on the storage unit 300, the sensor(s) 384 can acquire a reading or measurement for determining various conditions of the storage unit 300. In an embodiment, the system controller 385 is configured to use the sensor 384 to determine or measure the entire weight of the storage unit 300, the weight of the cargo product, the weight of various components of the storage unit 300, or the like. For example, the system controller 385 can use the sensor 384 to acquire a reading or measurement for determining accurate and/or real-time weight information, including, but not limited to, self-calibration of tare weight which eliminates a separate weighing process, indication of whether the storage unit was ever double or triple stacked which could damage a storage unit, weight information of the cargo to verify with the shipment documentation and to support the ability for the carrier of the transport unit to accurately charge customers based on the tare or gross weight and verify against the bill of lading, which can be displayed on the storage unit or sent via telematics, a total weight of the storage unit, e.g., including cargo, so that proper handling equipment can be used for loading and unloading, or the like.

It is understood that the term telematics can be generally related to monitoring the storage unit using GPS technology or the like to track movement and/or providing communications with the user or customer via the Internet, cellular, or the like related to the shipping and/or handling of the storage unit.

In some embodiments, the shipping/handling information of the storage unit 300 can be transmitted to and/or displayed on the HMI 395, for example, to indicate shipping information and/or handling requirements. The user interface of the display may show “Ready to ship” and/or shipping address, handling requirements, etc. In some embodiments, the HMI 395 may include a printer that receives the shipping/handling information of the storage unit 300. The printer may receive the shipping/handling information upon a user input, for example, on the HMI 395 confirming the shipping/handling information. In some embodiments, the HMI 395 can communicate with a shipping system for data logging.

In an embodiment, if no weight is detected in the interior space 315, the system controller 385 can instruct the climate control system 383 to automatically shut off. In another embodiment, if a weight is detected in the interior space 315, an operating instruction can be executed, for example, to interrupt operating of a cleaning unit, e.g. an UV-C cleaning cycle.

In an embodiment, the sensor 384 can be used in conjunction with the second sensor 384 to provide sensor fusion, e.g., increased information based on sensor measurement of the two sensors. For example, the second sensor 384 can be an accelerometer, thermometer, such that based on the sensors 384 detecting a rapid change in weight reading and temperature reading. The system controller 385 can deduce an occupancy or a safety condition of the storage unit 300 based on the rapid change and for instructing an operation (e.g., turning on or off a cleaning unit) of the storage unit 300 to prevent or reduce damage to operators, cargo, the storage unit 300 itself, or the like.

In an embodiment, the sensor 384 can include visual or optical systems such as a camera, a light sensor, an IR sensor, or the like. A computer vision system can receive the measurement(s) acquired by the sensor 384 to determine a condition related to the storage unit 300 for instructing an operation (e.g., turning on or off a cleaning unit) of the storage unit 300 to prevent or reduce damage to operators, cargo, the storage unit 300 itself, or the like.

The cleaning unit 325 can include a UV-C source, for example, an UV-C light bulb, an UV-C light emitting light fixture, or the like. In some embodiments, the cleaning unit 325 can be a fluid cleaner that is configured to attach a cleaning fluid from a fluid source 326 to the cleaning unit 325 for cleaning the storage unit 300. The fluid source 326 can provide a cleaning fluid. For example, the cleaning fluid can include pressurized gaseous or water, disinfecting/sterilizing gaseous (e.g., dry high temperature air, etc.), chemical or chemical cleaners, reactive oxygen species (e.g., singlet oxygen, ozone, atomic oxygen, Superoxide, hydrogen peroxide, hydroxyl radical, peroxynitrite, etc.), or the like. The fluid cleaner can include a hose 327 to distribute the cleaning fluid within the storage unit 300.

It is appreciated that the cleaning unit 325 is not limited to equipment and structures installed in the storage unit 300. For example, the cleaning unit 325 may be disposed on a removable/portable mechanical system 325A to be carried into or out of the storage unit 300, e.g., by an operator. As illustrated in FIG. 4, the mechanical system 325A is a stand.

In an embodiment, the cleaning unit 325 can be powered by the storage unit 300 and/or an external power source. For example, the cleaning unit 325 can be powered by the power source 386, plugging into a power outlet, external battery, or the like. The cleaning unit 325 can be controlled, for example, by the system controller 385 and/or a controller in a remote system.

In an embodiment, the storage unit 300 can include one or more status indication lights 340. The status indication light 340 can be configured to provide high visibility, e.g., having a brightness or luminosity that is discernible from any background, for the storage unit 300. The status indication light 40 can include a plurality of light sources including, but not limited to, light-emitting diodes, gas discharge bulbs, graphene bulbs, or the like. In an embodiment, the controller 385 can turn on the status indication light 340 to indicate the position of the door 337. For example, the controller 385 can turn on the status indication light 340 when the controller 385 determines the door 337 is opened.

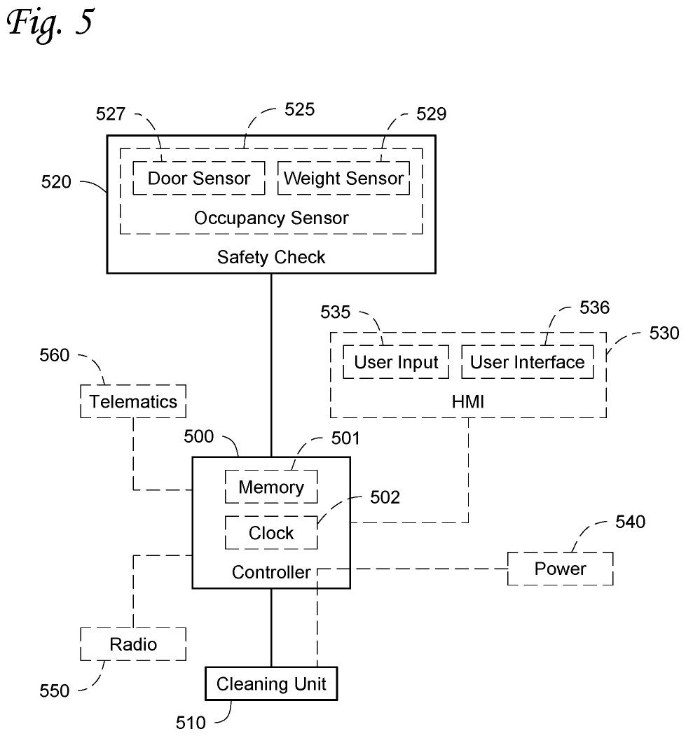

FIG. 5 is a schematic diagram of the controller 500, according to an embodiment.

As illustrated in FIG. 5, the controller 500 is in communication with a cleaning unit 510. In an embodiment, the controller 500 can be in communication with a HMI 530, a power source 540, a radio transceiver 550, a telematics system 560, or the like. The controller 500, the cleaning unit 510, the HMI 530, and the power source 540 can be the system controller 385, the HMI 395, the power source 386 for the storage unit 300 respectively, as shown e.g., in FIGS. 2-4. The radio transceiver 550 and the telematics system 560 can be integrated into the TU 150 and/or the storage unit 300 as shown, for example, in FIGS. 2-4.

The controller 500 can be configured to control the cleaning unit 510 according to inputs and/or sensor measurements received by the controller 500. The controller 500 can include a microprocessor configured to determine at least one instruction or output based on at least one received input (e.g., sensor measurements, etc.). The controller 500 can include a memory 501 for storing data, a clock 502 for recording time, a radio transceiver for communication via wireless radio wave, a port for wired communication, or the like. For example, the controller 500 can receive sensor measurement from a sensor, receive a user instruction of turning on the cleaning unit 510, determine whether the storage unit (e.g., the storage unit 300 of FIGS. 1-4) is safe to clean, transmit an instruction to turn on the cleaning unit 510, and/or the like. In some embodiments, the memory 501 can receive and store a database that records cleaning records generated and/or provided by the controller 500. It is appreciated that a portion of the memory 501 can be located on the controller 500, remotely from the HMI 530 and/or the like. Remote or partially remote memory can provide, for example, large storage space, allowing centralized processing, fleet manager oversights, securities, and/or the like.

The cleaning unit 510 can be any one or more of the cleaning units as shown and described above that is configured to clean the storage unit, e.g., by irradiation of the interior of the climate controlled space of the storage unit. It is appreciated that the cleaning unit 510 can include a dedicated controller and/or an integrated controller with the controller 500 of the storage unit.

A safety check 520 can be conducted to determine the storage unit being safe or unsafe to clean based on the reading or measurement received from the sensor(s). The safety check can be conducted by a controller module integrated in, or separated from, the controller 500. As shown in FIG. 5, the controller module conducting the safety check 520 can communicate with one or more occupancy sensors 525 for determining whether the storage unit is occupied and/or safe to clean. For example, the occupancy sensor 525 can include a door sensor 527 and/or a weight sensor 529. A controller (e.g., controller 500) can determine the occupancy of the storage unit and/or whether the storage unit is safe to clean. The controller 500 can turn on the cleaning unit 510, for example, when the controller determines the storage unit is safe to clean based on the safety check 520, the controller 500 receiving instructions (e.g., a user input, algorithmic input, etc. from the HMI 530) to turn on the cleaning unit 510, or the like, and/or a combination thereof.

It is appreciated that the occupancy sensors 525 are not limited to weight or door sensors (e.g., 527, 529). For example, the occupancy sensors 525 can include other sensor that acquires and transmits sensor readings or measurements to a controller to determine or deduce whether the storage unit is occupied by a human user, other animals, or cargo. Examples of other sensors can include a motion sensor, temperature sensor (i.e., infrared thermometer, thermocouple, infrared camera, or the like), optical camera, etc.

The HMI 530 can be a user device in communication with the controller 500. The HMI 530 can be disposed locally (e.g., onboard on the storage unit) and/or remotely (e.g., in the vehicle transporting the storage unit, at a remote fleet manager, etc.). The HMI 530 can be in communication with the controller 500, for example, by transmitting and receiving instructions between the controller 500 and the HMI 530. For example, the HMI 530 can transmit a user input 535 to the controller 500, e.g., for turning on or off the cleaning unit 510. In some embodiments, the HMI 530 can include a user interface 536, for example, that can be configured to display an alert or messages transited by the controller 500. In an embodiment, the user input 535 can be a switch or button indicating that the storage unit is safe to clean.

The power source 540 can provide power to the cleaning unit 510. In an embodiment, the power source 540 can be a power source onboard the storage unit. In some embodiments, the power source 540 can be a power outlet coupled to the cleaning unit 510 to provide electrical power from an external power source (e.g., power supply from a warehouse, the TU transporting the storage unit, external battery, generator, or the like).

The radio transceiver 550 can be in communication with the controller, the sensor, the HMI, or the like, for sending and/or receiving sensor readings, instructions, user input, and/or the like. It is appreciated that the radio transceiver 550 can be a dedicated electronic device included in the storage unit, and/or otherwise integrated into the storage unit, for example, as part of the controller 500, the telematics system 560, and/or the like.

The telematics system 560 can include one or more systems that facilitate communications between the vehicle (e.g., 190 of FIG. 1), one or more sensors of the vehicle, a TU, a storage unit, a controller, or the like. In some embodiments, other sensors or devices, such as GPS, cellular communication radio, memory, computational resources, database, etc. can be included in the telematics system 560, for example, to provide useful information to the controller 500. For example, the telematics system 560 can host a controller module to conduct the safety check 520 and output the determined safe or unsafe to clean to the controller 500 as an input to the controller 500. For another example, the occupancy sensor 525, the door sensor 527, the weight sensor 529, or the like, can be included in or be a part of, the telematics system 560.

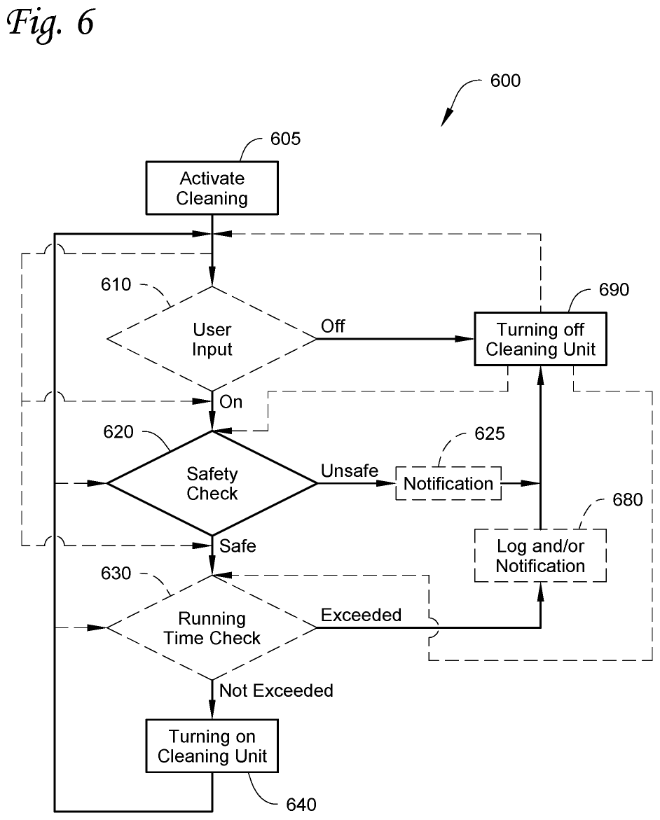

FIG. 6 shows a method 600 for cleaning a storage unit (e.g., the storage unit 300 shown in FIGS. 2-4), according to an embodiment. The method 600 can be implemented by a controller. In some embodiments, the controller can be the controller 500 as shown in FIG. 5 and/or the system controller 385 shown in FIG. 3.

As shown in FIG. 6, a control method 600 can be implemented on the controller. The method 600 begins by the controller activating cleaning 605, of example, as part of a starting up routine for the controller, as instructed by an algorithmic input or manual input from the user, or the like. The method 600 proceeds to 620. In some embodiments the method can proceed to optional 610, or to optional 630. In an embodiment, the method 600 can proceed to optional 610, 620, and/or optional 630 in parallel.

At optional 610, the controller can receive an instruction related to the cleaning unit. In an embodiment, the instruction can be a user input (e.g., user input 535 of FIG. 5) related to the cleaning unit (e.g., cleaning unit 510 of FIG. 5). If the user input instructs to turn on the cleaning unit, the method 600 proceeds to 620. If the user input instructs to turn off the cleaning unit, the method can proceed to 690.

It is appreciated that the user input can include a user generated input from a user interfere on an HMI for the storage unit, e.g., a button or switch. It is further appreciated that the user input can be alternatively or supplementally generated by a software implemented by a user (i.e., operator, engineer, fleet manager, or the like) automatically and/or algorithmically.

At 620, the controller performs a safety check to determine a safety condition for cleaning the storage unit. If safety condition determines that the storage unit is safe to clean, the method 600 proceeds to 640, optionally through 630. If the safety condition determines that the storage unit is unsafe to clean and/or unable to determine whether the storage unit is safe to clean, the method 600 proceeds to 690, optionally through 625.

At optional 630, the controller performs a running time check based on a clock (e.g., a timer, a real-time-clock module included in the controller 500, the telematics 560, the HMI 530, or the like). The clock can provide an input related to time (e.g., a current time, an amount of time passages relative to a reference point in time, or the like) to the controller. The controller is configured to compare a running time to a threshold time value. The running time can be an amount of time of which the cleaning unit had been turned on. For example, the threshold time valve and/or the running time can be any number of seconds, minutes, hours, or the like.

If the controller determines that the running time of the cleaning unit has not exceeded the predetermined time value, the method 600 proceeds to 640. If the controller determines that the running time has exceeded the predetermined time value, the method 600 proceeds to 690, optionally through 680. It is appreciated that, if the cleaning unit has been off, the running time determined by the controller may be zero, and the method 600 proceeds to 640.

At 640, the controller instructs the cleaning unit to turn on or remain turned on. In some embodiments, at 640, the method includes keeping the door (e.g., door 337 of FIG. 4) locked while the cleaning unit being turned on. The method 600 then proceeds to 620, optionally through 610 and/or 630, for continued operation of the cleaning unit and/or monitoring of the storage unit.

At optional 680, the controller records a completed cleaning cycle, e.g., in the database and/or transmits a notification to the user interface to alert a user that the cleaning has been completed. In an embodiment, the notification can be displayed, for example, on the user interface on the HMI. The notification can include displaying a message indicating that the cleaning has been completed. In an embodiment, the controller logs the completed cleaning cycle in a database, e.g., by providing an entry in the database a timing information, an information related to the cleaning has been completed, the threshold time value, and/or the like.

In some embodiments, at optional 625, the controller optionally proceeds from 620 to provide a notification when instructing the cleaning unit to turn off (e.g., terminating a cleaning cycle) or remain turned off based on the controller determines that the storage unit being unsafe to clean at 620. In an embodiment, the notification can be displayed, for example, on the user interface on the HMI. The notification can include displaying a message indicating that the storage unit is unsafe to clean, the cleaning cycle is terminated or interrupted due to the door being opened, and/or the like. In some embodiments, the notification at 625 can be recorded in the memory and or database accessible by the controller.

At 690, the controller instructs the cleaning unit to turn off or remain turned off. In some embodiments, at 690, the method includes unlocking the door (e.g., door 337 of FIG. 4). In an embodiment, the method 600 can proceed to 620, optionally through 610 and/or 630 for continued operation of the cleaning unit.

It is appreciated that the order of 610, 620, and 630 are illustrative and not limiting, such that the method can proceed in other orders (e.g., 630, 620, and 610; 620, 610, and 630; or the like). It is further appreciated that two or more of 610, 620, and 630 can be in series and/or in parallel such that, for example, when one or more of the user input being on at 610, safety check at 620, and the running time at 630, the method 600 proceeds to 640. In some embodiments, the method 600 can require that the user input being on at 610, the controller determines that the storage unit is safe to clean based on the safety check at 620, and the running time not exceeding the predetermined time threshold at 630 occur concurrently in order to proceed to 640. In some embodiments, before the method 600 proceeds to 640, additional method(s) may be included, for example, for checking power reserve, requesting approvals, etc.

In some embodiments, after the method proceed to 640 (e.g., turning on the cleaning unit), the method returns to 620 to monitor/determine, or continued to monitor/determine, whether the storage unit reminds safe to clean. For example, after the method 600 turning on the cleaning unit at 640, a living object undetected previously may be disturbed by the cleaning unit being on and start moving inside the cleaning unit. Then, the living object becomes detectable, for example, by a motion sensor. The method 600 then determines that the storage unit is unsafe to clean at 640 and proceeds to 690 to terminate the cleaning cycle or turn off the cleaning unit. In another example, after the method 600 turning on the cleaning unit at 640, the controller determines (e.g., via door sensor 527 of FIG. 5) that the door is opened, method 600 determines that the storage unit is unsafe to clean at 640 and proceeds to 690 to terminate the cleaning cycle and/or turn off the cleaning unit.

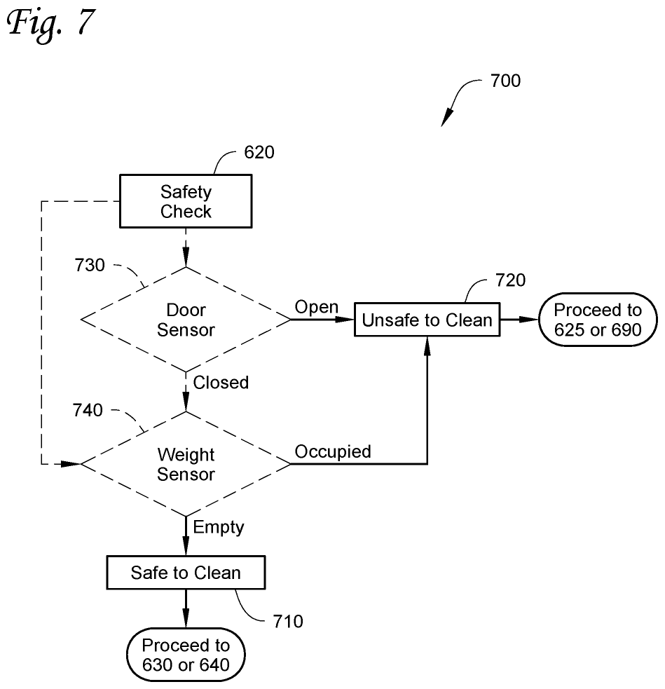

FIG. 7 shows a method 700 for determining whether the storage unit is safe to clean based on a safety check, according to an embodiment. In some embodiments, the safety check can be the safety check occurring at 620 in FIG. 6.

The method 700 begins at 620 with the controller (e.g., the controller 500 shown in FIG. 5 and/or the system controller 385 shown in FIG. 3) conducting a safety check (e.g., safety check at 620 in FIG. 6). The method 700 then proceeds to one of optional 730 and optional 740.

At optional 730, the controller receives an input from a door sensor. The input from the door sensor can include a reading or measurement related to the position of a door (e.g., door 337 of FIG. 4). In an embodiment, the controller can be the same controller performing the method 600 of FIG. 6 or another controller determining whether the storage unit is safe to clean and providing the determined information to the controller of method 600 of FIG. 6 as an input. In an embodiment, if the controller receives a door sensor measurement and determines the door is closed, the controller may determine the storage unit is safe to clean and the method 700 can proceed to 710, optionally through 740. If the controller receives a door sensor measurement and determines the door is open (during or before the cleaning unit is turned on), the controller may determine the storage unit is, or become, unsafe to clean, and the method 700 proceeds to 720.

At optional 740, the controller receives an input from one or more weight sensors. The input from one or more weight sensors can include a reading or measurement related to the gross weight of the storage unit. The gross weight can be compared to a threshold weight value to determine or deduce the occupancy of the storage unit. The reading or measurement can be a weight of an object (e.g., cargo, human, or the like) inside PCU. If the controller determines the weight is above a threshold weight value based on the input from the weight sensor(s), the controller determines the storage unit is occupied and unsafe to clean. If the weight is below a threshold weight value, the controller determines the storage unit is empty, or sufficiently emptied, and is safe to clean.

If the controller determines that the storage unit is empty based on the input from one or more weight sensors, the method 700 proceeds to 710. If the controller determines, based on the safety check, that the storage unit is occupied based on the input from one or more weight sensor, the controller determines the storage unit is unsafe to clean and the method 700 proceeds to 720.

At 720, upon the controller determine the storage unit is unsafe to clean (e.g., due to a determination that the door is open while the cleaning unit is turned on), the method proceeds to 625 and/or 690 to stop the cleaning unit and/or prevent the cleaning unit from being turned on.

It is appreciated that the order of the 730 and 740 is illustrative and not limiting, such that the method can proceed in other orders (e.g., 740 and 730). It is further appreciated that 740 and 730 can be in parallel such that, for example, when one or more of the storage unit is determined to be sufficiently empty at 740 and the door being closed at 730, the method 700 may proceed to 710.

At 710, the controller determines that the storage unit is safe to clean. In some embodiments, the controller can provide a notification that the storage unit is safe to clean. In some embodiments, the notification can be displayed, for example, on the user interface on the HMI. The notification can include displaying a message indicating that the storage unit is safe to clean. In some embodiments, the notification can be recorded in the memory and or database accessible by the controller. In some embodiments, at 710, the method includes locking the door (e.g., door 337 of FIG. 4) before proceeding to 630 or 640, for example, to prevent unintentional opening of the door when the cleaning unit is on.

It is appreciated that the controller may be not limited to determine the storage unit is safe or unsafe to clean. For example, the controller can determine that the situation is unclear or undeterminable and/or trigging a notification to the user interface, e.g., due to sensor errors, battery errors, or the like.

It is further appreciated that controller may not be limited to the exemplary embodiments described above in determining the storage unit being safe or unsafe to clean based on the safety check. The controller can determine whether the storage unit being safe of unsafe to clean based on the type of cargo in the climate controlled space (e.g., 315 of FIG. 4), the type of cleaning or cleaning unit, the area or space being cleaned, or the like. For example, the controller can determine the storage unit is safe to clean when the door is closed, while the cargo in the storage unit is a type of cargo that can sustain the cleaning method of the cleaning unit. It is further appreciated that the controller can determine the storage unit is safe to clean when the door is opened, for example, when the cleaning unit cleans by washing with water. For another example, the occupancy can be determined by other sensors such as optical, motion, or light sensors.

Aspects: Any of aspects 1-9 can be combined with any one of aspects 10-20.
Aspect 1. A method for cleaning an electrically powered portable self-contained climate controlled storage unit, the method comprising:
   a sensor monitoring a safety condition of the electrically powered portable self-contained climate controlled storage unit;
   a controller receiving a reading related to the safety condition from the sensor;
   the controller performing a safety check based on the reading received from the sensor; and
   the controller instructing the cleaning unit to clean the electrically powered portable self-contained climate controlled storage unit upon the controller determining the electrically powered portable self-contained climate controlled storage unit is safe to clean based on the safety check.
Aspect 2. The method for cleaning the electrically powered portable self-contained climate controlled storage unit of aspect 1, further comprising
   the controller instructing the cleaning unit to stop cleaning the electrically powered portable self-contained climate controlled storage unit upon the controller determining the electrically powered portable self-contained climate controlled storage unit is unsafe to clean based on the safety check.
Aspect 3. The method for cleaning the electrically powered portable self-contained climate controlled storage unit of aspect 1 or 2, further comprising
   the controller instructing to clean by turning on a UV-C source of the cleaning unit; and
   the UV-C source emitting UV-C light in the climate controlled space upon the UV-C source being turned on.
Aspect 4. The method for cleaning the electrically powered portable self-contained climate controlled storage unit of any one of aspects 1-3, further comprising
   the controller instructing to clean by turning on a fluid cleaner of the cleaning unit;
   the fluid cleaner receiving a cleaning fluid from a fluid source; and
   the fluid cleaner spraying the cleaning fluid in the climate controlled space upon the fluid cleaner being turned on.
Aspect 5. The method of cleaning the electrically powered portable self-contained climate controlled storage system of any one of aspects 1-4, further comprising:
   the controller monitoring a running time of the cleaning unit; and
   the controller turning off the cleaning unit upon the controller determining that the running time exceeds a threshold time value.
Aspect 6. The method of cleaning the electrically powered portable self-contained climate controlled storage system of any one of aspects 1-5, wherein
   the sensor comprises a door sensor configured to provide the safety condition, and
   the controller conducts the safety check to determine the electrically powered portable self-contained climate controlled storage system being unsafe to clean upon the controller determines the door is open based on the safety check.
Aspect 7. The method of cleaning the electrically powered portable self-contained climate controlled storage system of any one of aspects 1-6, further comprising:
   the controller monitoring a running time; and
   the controller sending a record of a completed cleaning cycle upon the controller determining that the running time exceeds a threshold time value.
Aspect 8. The method of cleaning the electrically powered portable self-contained climate controlled storage system of any one of aspects 1-7, wherein
   the sensor comprises a weight sensor configured to provide the safety condition, and
   the controller conducts the safety check to determine the electrically powered portable self-contained climate controlled storage system being unsafe to clean upon the controller determining the container exceeding a threshold weight value based on the safety check.
Aspect 9. The method of cleaning the electrically powered portable self-contained climate controlled storage system of any one of aspects 1-8, further comprising:
   the controller monitoring a running time of the cleaning unit; and
   the controller sending an alert of a completed cleaning cycle to a user interface upon the controller determining that the running time exceeds a threshold time value.
Aspect 10. An electrically powered portable self-contained climate controlled storage system comprising:
   an electrically powered portable self-contained climate controlled storage unit that comprises: a base supporting a climate controlled space, a climate control system configured to provide climate control to the climate controlled space, a door for provide access to the climate controlled space;
   a sensor configured to provide a reading related a safety condition of the electrically powered portable self-contained climate controlled storage unit; and
   a controller configured to:
      receive the reading from the sensor,
      performing a safety check based on the reading received from the sensor, and
      instruct a cleaning unit to clean the electrically powered portable self-contained climate controlled storage unit upon the controller determining the electrically powered portable self-contained climate controlled storage unit is safe to clean based on the safety check.
Aspect 11. The electrically powered portable self-contained climate controlled storage system of any one of aspect 10, further comprising
   the controller instructing the cleaning unit to stop cleaning the electrically powered portable self-contained climate controlled storage unit upon the controller determining the electrically powered portable self-contained climate controlled storage unit is unsafe to clean based on the safety check.
Aspect 12. The electrically powered portable self-contained climate controlled storage system of aspect 10 or 11, wherein the cleaning unit comprises
   a UV-C source disposed in the electrically powered portable self-contained climate controlled storage unit and configured to irradiate in the electrically powered portable self-contained climate controlled storage unit to clean the climate controlled space with UV-C light.
Aspect 13. The electrically powered portable self-contained climate controlled storage system of any one of aspects 10-12, wherein
   the cleaning unit comprises a fluid cleaner disposed on the container and configured to
      connect to a fluid source,
      receive a cleaning fluid from the fluid source, and
      clean inside of the electrically powered portable self-contained climate controlled storage unit by spraying the climate controlled space with the cleaning fluid upon instructed by the controller.
Aspect 14. The electrically powered portable self-contained climate controlled storage system of any one of aspects 10-13, wherein
   the sensor comprises a door sensor configured to provide the reading related to the safety condition based on a position of the door.
Aspect 15. The electrically powered portable self-contained climate controlled storage system of any one of aspects 10-14, wherein
   the sensor comprises a weight sensor configured to provide the reading related to the safety condition related to a weight of the electrically powered portable self-contained climate controlled storage unit.
Aspect 16. The electrically powered portable self-contained climate controlled storage system of any one of aspects 10-15, wherein
   the electrically powered portable self-contained climate controlled storage unit contains a battery that provides electricity to the cleaning unit.
Aspect 17. The electrically powered portable self-contained climate controlled storage system of any one of aspects 10-16, wherein
   the cleaning unit is disposed on a stand removable from the electrically powered portable self-contained climate controlled storage unit, and the stand supports the cleaning unit.
Aspect 18. The electrically powered portable self-contained climate controlled storage system of any one of aspects 10-17, wherein
   the cleaning unit includes a fluid cleaner including a hose configured to distribute a cleaning fluid for cleaning the electrically powered portable self-contained climate controlled storage.
Aspect 19. The electrically powered portable self-contained climate controlled storage system of any one of aspects 10-18, wherein
   the cleaning unit is disposed in the electrically powered portable self-contained climate controlled storage.
Aspect 20. The electrically powered portable self-contained climate controlled storage system of any one of aspect 10-19, wherein
   the cleaning unit is disposed in a transport unit that is configured to transport the electrically powered portable self-contained climate controlled storage unit.

1. A method for cleaning an electrically powered portable self-contained climate controlled storage unit including a climate controlled space, the method comprising:
a sensor monitoring a human occupancy condition in the climate controlled space of the electrically powered portable self-contained climate controlled storage unit;
a controller receiving a reading related to the human occupancy condition from the sensor;
the controller performing a safety check based on the reading received from the sensor; and
the controller instructing the cleaning unit to clean the electrically powered portable self-contained climate controlled storage unit upon the controller determining the electrically powered portable self-contained climate controlled storage unit is unoccupied by a human based on the safety check, wherein the controller instructing the cleaning unit to clean includes:
turning on a UV-C source of the cleaning unit, and
the UV-C source emitting UV-C light in the climate controlled space upon the UV-C source being turned on.

2. The method for cleaning the electrically powered portable self-contained climate controlled storage unit of claim 1, further comprising
the controller instructing the cleaning unit to stop cleaning the electrically powered portable self-contained climate controlled storage unit upon the controller determining the electrically powered portable self-contained climate controlled storage unit is occupied by a human based on the safety check.

3. (canceled)

4. The method for cleaning the electrically powered portable self-contained climate controlled storage unit of claim 1, further comprising
the controller instructing to clean by turning on a fluid cleaner of the cleaning unit;
the fluid cleaner receiving a cleaning fluid from a fluid source; and
the fluid cleaner spraying the cleaning fluid in the climate controlled space upon the fluid cleaner being turned on.

5. The method of cleaning the electrically powered portable self-contained climate controlled storage unit of claim 1, further comprising:
the controller monitoring a running time of the cleaning unit; and
the controller turning off the cleaning unit upon the controller determining that the running time exceeds a threshold time value.

6. The method of cleaning the electrically powered portable self-contained climate controlled storage unit of claim 1, wherein
the sensor comprises a door sensor configured to provide the safety condition, and
the controller conducts the safety check to determine the electrically powered portable self-contained climate controlled storage unit being unsafe to clean upon the controller determines the door is open based on the safety check.

7. The method of cleaning the electrically powered portable self-contained climate controlled storage unit of claim 1, further comprising:
the controller monitoring a running time; and
the controller sending a record of a completed cleaning cycle upon the controller determining that the running time exceeds a threshold time value.

8. The method of cleaning the electrically powered portable self-contained climate controlled storage unit of claim 1, wherein
the sensor comprises a weight sensor configured to provide the condition, and
the controller conducts the safety check to determine the electrically powered portable self-contained climate controlled storage unit being unsafe to clean upon the controller determining the container exceeding a threshold weight value based on the safety check.

9. The method of cleaning the electrically powered portable self-contained climate controlled storage unit of claim 1, further comprising:
the controller monitoring a running time of the cleaning unit; and
the controller sending an alert of a completed cleaning cycle to a user interface upon the controller determining that the running time exceeds a threshold time value.

10. An electrically powered portable self-contained climate controlled storage unit comprising:
an electrically powered portable self-contained climate controlled storage unit that comprises: a base supporting a climate controlled space, a climate control system configured to provide climate control to the climate controlled space, a door for provide access to the climate controlled space;
a UV-C source disposed in the electrically powered portable self-contained climate controlled storage unit and configured to irradiate in the electrically powered portable self-contained climate controlled storage unit to clean the climate controlled space with UV-C light a sensor configured to provide a reading related a human occupancy condition of the electrically powered portable self-contained climate controlled storage unit; and
a controller configured to:
receive the reading from the sensor,
performing a safety check based on the reading received from the sensor, and
instruct a cleaning unit to clean the electrically powered portable self-contained climate controlled storage unit upon the controller determining the electrically powered portable self-contained climate controlled storage unit is unoccupied by a human based on the safety check, wherein instructing the cleaning unit to clean includes turning on a UV-C source of the cleaning unit which causes the UV-C source to emit UV-C light in the climate controlled space.

11. The electrically powered portable self-contained climate controlled storage unit of claim 10, further comprising
the controller instructing the cleaning unit to stop cleaning the electrically powered portable self-contained climate controlled storage unit upon the controller determining the electrically powered portable self-contained climate controlled storage unit is occupied by a human based on the safety check.

12. (canceled)

13. The electrically powered portable self-contained climate controlled storage unit of claim 10, wherein
the cleaning unit comprises a fluid cleaner disposed on the container and configured to connect to a fluid source,
receive a cleaning fluid from the fluid source, and
clean inside of the electrically powered portable self-contained climate controlled storage unit by spraying the climate controlled space with the cleaning fluid upon instructed by the controller.

14. The electrically powered portable self-contained climate controlled storage unit of claim 10, wherein
the sensor comprises a door sensor configured to provide the reading related to the condition based on a position of the door.

15. The electrically powered portable self-contained climate controlled storage unit of claim 10, wherein
the sensor comprises a weight sensor configured to provide the reading related to the condition related to a weight of the electrically powered portable self-contained climate controlled storage unit.

16. The electrically powered portable self-contained climate controlled storage unit of claim 10, wherein
the electrically powered portable self-contained climate controlled storage unit contains a battery that provides electricity to the cleaning unit.

17. The electrically powered portable self-contained climate controlled storage unit of claim 10, wherein
the cleaning unit is disposed on a stand removable from the electrically powered portable self-contained climate controlled storage unit, and the stand supports the cleaning unit.

18. The electrically powered portable self-contained climate controlled storage unit of claim 10, wherein
the cleaning unit includes a fluid cleaner including a hose configured to distribute a cleaning fluid for cleaning the electrically powered portable self-contained climate controlled storage unit.

19. The electrically powered portable self-contained climate controlled storage unit of claim 10, wherein
the cleaning unit is disposed in the electrically powered portable self-contained climate controlled storage unit.

20. The electrically powered portable self-contained climate controlled storage unit of claim 10, wherein
the cleaning unit is disposed in a transport unit that is configured to transport the electrically powered portable self-contained climate controlled storage unit.
